(19) United States
(12) Patent Application Publication
(10) Pub. No.: US 2015/0365293 A1
(43) Pub. Date: Dec. 17, 2015

(54) ENFORCING POLICIES BASED ON INFORMATION RECEIVED FROM EXTERNAL SYSTEMS

(71) Applicant: Uber Technologies, Inc., San Francisco, CA (US)

(72) Inventors: Luis Madrigal, San Francisco, CA (US); Chris Cravens, San Francisco, CA (US)

(21) Appl. No.: 14/737,700

(22) Filed: Jun. 12, 2015

Related U.S. Application Data
(60) Provisional application No. 62/012,126, filed on Jun. 13, 2014.

(51) Int. Cl. H04L 12/24; H04L 29/06

(52) U.S. Cl. CPC H04L 41/0893; H04L 63/20

(57) ABSTRACT

A system for enforcing policies is described. The system can receive information about one or more computing devices from each of a mobile device management (MDM) system and a machine-to-machine (M2M) system. Each of the MDM system and the M2M system can receive information from or be in communication with the one or more computing devices. Based on the information received, the system can identify a policy from a set of policies, and transmit a request to either or both of the MDM system or M2M system to perform an action based on the identified policy.

### RELATED APPLICATIONS

This application claims the benefit of priority to U.S. Provisional Patent Application No. 62/012,126, filed Jun. 13, 2014, titled ENFORCING POLICIES BASED ON INFORMATION RECEIVED FROM EXTERNAL SYSTEMS; the aforementioned application being incorporated by reference in its entirety.

### BACKGROUND OF THE INVENTION

A mobile device management (MDM) system typically manages and supports a variety of mobile computing devices, such as smartphones, tablet devices, mobile point-of-sale devices, etc. In some examples, the MDM system can control what data can be provided to such computing devices.

### BRIEF DESCRIPTION OF THE DRAWINGS

FIG. 1 illustrates an example system to enforce one or more policies for one or more computing devices, under an embodiment.

FIGS. 2 through 5 illustrate example methods for enforcing one or more policies based on information received from a mobile device management system (MDM) and/or a machine-to-machine (M2M) system, according to some embodiments.

FIG. 6 is a block diagram that illustrates a computer system upon which embodiments described herein may be implemented.

FIG. 7 is a block diagram that illustrates a mobile computing device upon which embodiments described herein may be implemented.

### DETAILED DESCRIPTION

Examples described herein provide for a compliance system to communicate with each of a mobile device management (MDM) system and a machine-to-machine (M2M) system for purposes of establishing and/or enforcing policies that are based on information received from one or both of the MDM or the M2M systems.

In some examples, an enterprise or an entity can control, operate, and/or implement the compliance system for purposes of managing a fleet of computing devices that are owned and controlled, at least in part, by the entity. For example, the entity can arrange an on-demand service for clients who can request services through use of their own computing devices (referred to herein as a “service arrangement entity”). The entity can provide a plurality of computing devices, such as a fleet of smartphones, to a group of service providers to enable the service providers to receive invitations to provide the requested services. Accordingly, in some examples, the compliance system can be in communication with an on-demand service system operated by the entity. Although the devices are in possession of the service providers, the entity can generate and use policies for managing and controlling their devices through use of the compliance system, so as to ensure that the devices are being used appropriately by the service providers. Because the entity owns the devices, the compliance system can be used to change the functionality, operation, or status of a compliance-violating device.

According to an example, the compliance system can receive information associated with the plurality of devices from the MDM system and/or the M2M system. Depending on implementation, the MDM system can be implemented and/or controlled by a third-party entity (referred to herein as an “MDM entity”) that provides a device management service to the entity operating the compliance system. The M2M system can be implemented and/or controlled by a telecommunication network provider (referred to herein as a “network provider”) that provides network connectivity for the plurality of devices over one or more networks, such as over a cellular network(s). For example, the plurality of computing devices can communicate with the compliance system over the cellular network(s) provided by the network provider. The MDM entity, the network provider, and the entity operating the compliance system can each be different entities. In other variations, the MDM system and/or the M2M system can be implemented and/or controlled by the entity operating the compliance system.

Each of the MDM system and the M2M system can be in communication with the plurality of computing devices. The MDM system and the M2M system can provide a variety of information associated with the plurality of devices (referred to herein as “device information”) to the compliance system (e.g., periodically, based on a schedule, continuously, etc.). Based on the device information received from the MDM system and/or the M2M system, the compliance system can identify a policy from a set of policies that specifies an action that is to be performed by the compliance system, the MDM system, and/or the M2M system. Still further, in one or more examples, the compliance system can also identify and enforce policies based on data that the compliance system maintains in a database or an accessible data store.

For example, based on information received from the MDM system that a particular application is present (e.g., stored) on a device of the plurality of devices, the compliance system can identify a policy based on the information, and transmit, to the M2M system, a request to change a configuration of that device based on the identified policy. In another example, the compliance system can determine, by monitoring the plurality of computing devices, that a computing device has not operated a specific application for a predetermined amount of time. A policy can instruct the compliance system to perform an action (e.g., a remedial action) when the compliance system detects or determines such a condition. The compliance system can transmit a request to the M2M system, for example, to change a configuration of that device from an activated state to a deactivated state. In other examples, the compliance system can use information received from the M2M system about a computing device and transmit a request to the MDM system to change a configuration or a setting in that computing device.

Among benefits and technical effects achieved with examples as described, the compliance system can provide a mechanism to enable an entity to remotely monitor a fleet of computing devices to programmatically determine whether those users are using those computing devices in a permissive manner. The compliance system can leverage the use of other systems, such as the MDM system or the M2M system, to control the computing devices for purposes of enforcing policies.

As used herein, a device, a computing device, or a mobile computing device, in general, refer to devices corresponding to cellular devices or smartphones, personal digital assistants (PDAs), laptop computers, tablet devices, etc., that can provide network connectivity and processing resources for communicating with the system over one or more networks (e.g., using data channels over one or more cellular networks, etc.). In examples described herein, the devices, such as those owned by the service arrangement entity operating the compliance system and/or the on-demand service system and provided to service providers, can individually operate a designated service application that is capable of communicating with the compliance system and/or the on-demand service system.

Still further, examples described herein relate to on-demand services, such as transport services, food truck services, delivery services, entertainment services, etc., that can be arranged between individuals (e.g., clients or riders) and service providers by an on-demand service system. For example, a user can request an on-demand service, such as a delivery service (e.g., food delivery, messenger service, food truck service, or product shipping service, etc.) or an entertainment service (e.g., mariachi band, string quartet, etc.) using the on-demand service system, and the on-demand service system can select a service provider, such as a driver, a food provider, a band, etc., to provide the requested on-demand service for the user.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, printers, digital picture frames, network equipment (e.g., routers or switches), and tablet devices. Memory, processing, and network resources may all be used in connection with the establishment, use, or performance of any embodiment described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples discussed herein can be carried and/or executed. In particular, the numerous machines shown with examples herein include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

### System Description

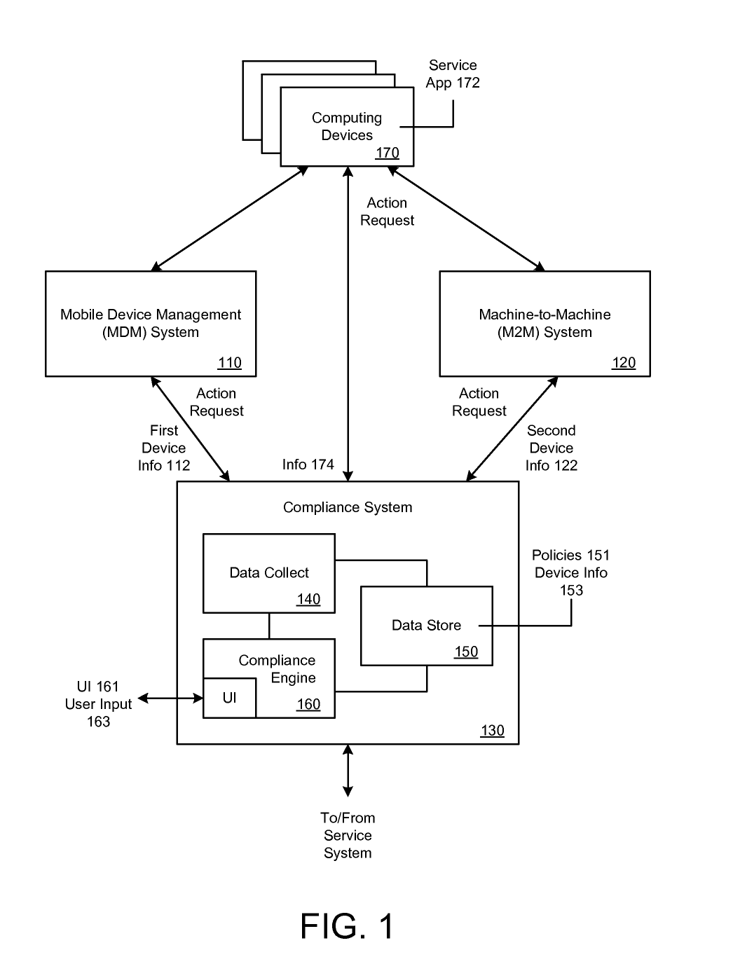

FIG. 1 illustrates an example system to enforce one or more policies for one or more computing devices, under an embodiment. In some examples, a compliance system can communicate with an MDM system and a M2M system for purposes of receiving device information associated with a plurality of devices. The MDM system can communicate with the plurality of devices for purposes of providing security, root detection, data or content delivery, restrictions, etc., on behalf of the compliance system. In addition, a network provider (or another associated entity) can implement the M2M system, which can provide telecommunications management and device management for the plurality of devices that are connected to and use the network(s) provided by the network provider. According to examples, these plurality of devices can be owned by the service arrangement entity operating the compliance system, but provided to service providers for use with a service system.

As illustrated in FIG. 1, the MDM system 110 can be in communication with a plurality of computing devices 170 to receive (e.g., periodically at a first rate) a first set of device information associated with the plurality of computing devices 170. For example, a client service or program operating on each of the computing devices 170 can cause device information to be provided to the MDM system 110. The MDM system 110 can also communicate with the compliance system 130, via respective system interfaces (not shown in FIG. 1), to provide some or all of the first set of device information to the compliance system 130. Similarly, the M2M system 120 can be in communication with the plurality of computing devices 170 to also receive (e.g., periodically at a first rate or a different second rate) a second set of device information associated with the plurality of computing devices 170. A client service or program associated with the M2M system 120 can operate on each of the computing devices 170 to cause device information to be provided to the M2M system 120. The M2M system 120 can provide some or all of the second set of device information to the compliance system 130, via respective system interfaces (not shown in FIG. 1). Depending on implementation, the first set of device information and the second set of device information can include similar, identical, and/or different information associated with the plurality of computing devices 170.

Each of the plurality of computing devices 170 can also include a designated service application 172 that can operate on the respective computing device 170 (e.g., stored in its respective local memory resource). As described herein, a designated service application 172 is an application that is provided by the service arrangement entity to enable the service application 172 to communicate with the on-demand service system (not shown in FIG. 1 for purpose of simplicity) and the compliance system 130. The on-demand service system (also referred to herein as “the service system”) can receive requests from clients for on-demand services (also referred to herein as “services”) and can arrange those services to be provided by service providers operating the computing devices 170. In the case of service providers, the service arrangement entity can provide computing devices 170 to those service providers with the service application 172 pre-installed on the computing devices 170. A service provider can launch the service application 172 on her device 170, for example, when she wants to go on-duty and be available for providing service(s) to requesting clients. The service application 172 can be programmed to exchange data with the compliance system 130 as well as the service system. In some examples, the compliance system 130 can be in communication with and/or be a part of the service system. The compliance system 130 can provide a framework for the service system to enable the service system to perform policy enforcement processes based on device information received from the MDM system 110, the M2M system 120, and/or the computing devices 170, as well as information previously received and stored in the compliance system 130.

In one example, the compliance system 130 enables a user (e.g., an administrator) of the compliance system 130 to generate policies 151 for managing the plurality of computing devices 170 based on device information received from the MDM system 110, device information received from the M2M system 120, and/or information received from the service applications running on the computing devices 170. The user of the compliance system 130 can interact with a user interface 161 (e.g., provided by a user interface component of the compliance system 130) by providing inputs 163 to create, edit, and/or delete policies 151. Such policies 151 can be individually and automatically enforced by the compliance system 130 when certain conditions are satisfied with respect to one or more of the computing devices 170. As referred to herein, enforcing a policy corresponds to (i) causing the MDM system 110 and/or the M2M system 120 to perform a specified action, and/or (ii) directing the computing device(s) 170 to perform a specified action (e.g., via a command sent to the service application running on the computing device(s) 170).

According to an example, the compliance system 130 includes a data collect 140, a data store 150, and a compliance engine 160. The compliance system 130 can also include one or more system and/or device interfaces (not shown in FIG. 1) to enable the compliance system 130 to exchange data with the MDM system 110, the M2M system 120, and the plurality of computing devices 170 (via the service applications running on the computing devices 170). The components of system 100 can combine to use data received from the MDM system 110, the M2M system 120, and/or the computing devices 170 to enforce one or more policies 151. Logic can be implemented with various applications (e.g., software) and/or with hardware of a computer system that implements the compliance system 130.

The compliance system 130 can be implemented on network side resources, such as on one or more servers (e.g., datacenters). Similarly, the MDM system 110 and the M2M system 120 can each be implemented on one or more servers that are operated by different entities, such as the MDM entity and the network provider, respectively. In some examples, the compliance system 130 can also be implemented through other computer systems in alternative architectures (e.g., peer-to-peer networks, etc.). As an addition or an alternative, some or all of the components of the compliance system 130 can be implemented on client devices, such as through applications that operate on the computing devices 170. For example, the service application can execute to perform one or more of the processes described by the various components of the compliance system 130.

The compliance system 130 can communicate, over one or more networks, with a plurality of computing devices 170 via a device interface (not shown in FIG. 1). The device interface can manage communications between the compliance system 130 and the computing devices 170. As discussed, the computing devices 170 can individually run a service application that can interface with the device interface to communicate with the compliance system 130. In some examples, the service applications can include or use an application programming interface (API), such as an externally facing API, to communicate data with the device interface. The externally facing API can provide access to system 100 via secure access channels over the network through any number of methods, such as web-based forms, programmatic access via restful APIs, Simple Object Access Protocol (SOAP), remote procedure call (RPC), scripting access, etc.

According to some examples, the data collect 140 can receive device information from the MDM system 110, device information from the M2M system 120, and information provided by the service applications running on the plurality of computing devices 170 (e.g., collectively referred to as “device information” for simplicity), and store the received device information 153 in the data store 150. In some variations, the information can be pushed by the MDM system 110, the M2M system 120, and/or the service applications running on the plurality of computing devices 170, or pulled from the respective sources by the data collect 140. The data collect 140 can receive or retrieve the information periodically (e.g., every ten seconds, twenty seconds, etc.) or intermittently based on user input (e.g., user input to update the data). In another example, the data collect 140 can be scheduled via user input (through interaction with a user interface displayed on a display device) to receive or retrieve the information based on a set schedule.

Depending on implementation, the first set of information 112 provided by the MDM system 110 can include, for each of the plurality of computing devices 170, one or more of information of a device type of that computing device, an identifier for that computing device (e.g., a unique serial number, such as an integrated circuit card identifier (ICCID), a mobile equipment identifier (MEID), an international mobile station equipment identity (IMEI), etc.), an internet protocol (IP) address, a media access control (MAC) address, carrier identifier, a profile(s) associated with the MDM system 110 stored on that computing device, application(s) that are installed on that computing device, the compliance status of that computing device (based on policies specified using the MDM system 110), location information about that computing device (e.g., global positioning system (GPS) data points), and other information.

The second set of information provided by the M2M system 120 can include, for each of the plurality of computing devices 170, one or more of a device identifier for that computing device, device activity information, an amount of data usage for that computing device (e.g., for a specified duration) on a network/system provided by the network provider, device status (e.g., the status of the device or the subscriber identity module (SIM) status), and other information. The service applications running on the plurality of computing devices 170 can also provide, for each of the plurality of computing devices, one or more of a service provider (e.g., a driver in the context of arranging transport services) or device identifier associated with that computing device, a time when the service application was launched or opened on the computing device, driver information pertaining to the transport service (e.g., the state of the driver or device, the location of the device and associated timestamp), etc. Such information 174 from the service application 172 can be stored in the data store 150 and updated when the data collect 140 receives the information.

In addition, in some examples, the compliance system 130 can also provide a user interface (e.g., as part of the compliance engine 160 or separate from the compliance engine 160 depending on implementation) to enable the user of the compliance system 130 to view the various information received by the data collect 140 on a display device. The data collect 140 can interface with or be provided (at least in part) by a respective portal (e.g., a web portal) that is in operation with each of the MDM system 110 or the M2M system 120. In this manner, a user can manually review current information about any of the plurality of computing devices 170 and cause the compliance system to transmit commands or requests to any of the MDM system 110, the M2M system 120, and/or the computing devices 170.

According to an example, the compliance system 130 can include the compliance engine 160, which can communicate with the data collect 140 and/or the data store 150 to access the most up-to-date, real-time, or close to real-time device information of the computing devices 170. In addition, the compliance engine 160 can access policies 151 stored in the data store 150 to determine which of the policies need to be enforced based on the device information. In one example, the compliance engine 160 can include or be in communication with a user interface (UI) component that provides UIs 161 to be displayed on a display device. The UI can include the device information received by the data collect 140 and enable the user to create, edit, and/or delete policies 151 for the compliance system 130 via user input 163. A policy 151 can instruct the compliance engine 160 to perform a specified action with respect to a computing device 170 when certain conditions are met.

Depending on variations, the compliance engine 130 can access the policies 151 whenever new or updated device information (as compared to the previously received device information) is received by the data collect 140 and/or can access the policies 151 periodically (e.g., access the policies first and then determine the most up-to-date device information). For individual computing devices 170, the compliance engine 130 can determine whether one or more polices 151 stored in the data store 150 are to be enforced based on the device information 153 (as well as previously stored information and information about drivers that operate the plurality of computing devices 170). For example, the compliance engine 130 can determine which of the policies 151 are applicable to the current conditions present with respect to an individual computing device 170 based on the device information for that computing device.

As an example, a first policy, Policy A, can specify that if the current or most-up-to-date device information of a computing device satisfies Condition X, the compliance engine 160 should enforce Policy A so that an action, Action 2, specified by Policy A is to be performed with respect to that computing device. A second policy, Policy B, can specify that if the current or most-up-to-date device information of a computing device satisfies Conditions Y and Z, the compliance engine 160 should enforce Policy B so that an action, Action 5, specified by Policy B is to be performed with respect to that computing device. The compliance engine 160 can use the device information for the plurality of computing devices 170 and the policies 151 stored in the data store 150 to identify one or more policies, if any, that are to be enforced for individual computing devices 170. In this example, based on device information of the devices at time, t=t1, the compliance engine 160 can determine that Policy A is to be enforced for a first computing device, no policy is to be enforced for a second computing device and a third computing device, and that Policy B is to be enforced for a fourth computing device. Based on the identified policies, the compliance engine 160 can (i) determine the respective actions that are to be performed for the respective devices, and (ii) transmit a request to perform the respective actions to the MDM system 110, the M2M system 120, and/or the service application 172 running on the respective devices (e.g., referred to herein as an “action request”).

An action request can include an identifier of the computing device 170 in which an identified policy is to be enforced, as well as information about what action is to be performed. Depending on implementation, the compliance system 130 can transmit an action request in a format and/or a protocol that is specific to the recipient of the action request, e.g., the MDM system 110, the M2M system 120, or the service application 172 on a computing device 170. When the MDM system 110, the M2M system, or the service application 172 receives an action request, the action request can cause the MDM system 110, the M2M system, or the service application 172, respectively, to perform a specified action from the identified policy with respect to the specified computing device 170.

For example, the compliance system 130 can identify a policy from a set of policies 151 that is to be enforced with respect to a computing device based on a first set of device information received from the M2M system 120. The policy can specify that an action is to be performed by the MDM system 110 with respect to that computing device, such as changing a configuration or a setting of that computing device, sending a message to that computing device, causing an application to be installed or uninstalled, etc. The compliance system 130 can generate and transmit an action request in the format and the protocol used to communicate with the MDM system 110, thereby enabling the MDM system 110 to use the information in the action request to perform the appropriate action on that computing device. The MDM system 110, for example, can transmit a signal to that computing device (e.g., using an identifier of that computing device) to change a configuration or setting associated with the action. In this manner, the compliance system 130 can use any combination of data from the MDM system 110, the M2M system 120, and the service application to cause the MDM system 110, the M2M system 120, and/or the service application to perform an action in order to enforce a policy. The action(s) performed with respect to a computing device can affect the functionality or status of the computing device, and in turn affect the service provider's interactions with the service system.

### Methodology

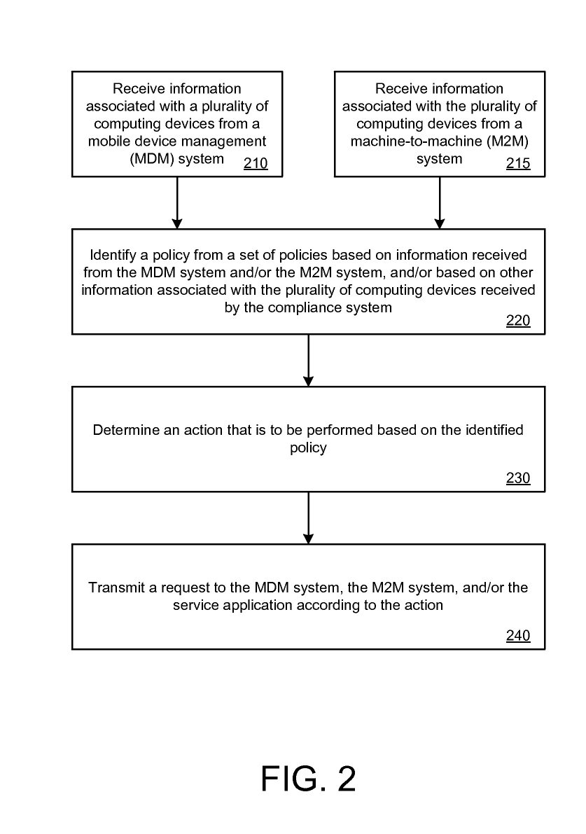

FIGS. 2 through 5 illustrate example methods for enforcing one or more policies based on information received from an MDM system and/or a M2M system, according to some embodiments. Methods such as described by examples of FIGS. 2 through 5 can be implemented using, for example, components described with an example of FIG. 1. Accordingly, references made to elements of FIG. 1 are for purposes of illustrating a suitable element or component for performing a step or sub-step being described.

FIG. 2 illustrates an example method performed by a compliance system that is in communication with both an MDM system and an M2M system, such as the compliance system 130 of FIG. 1. The compliance system 130 can receive information associated with a plurality of computing devices from the MDM system (e.g., referred to as a first set of device information) (210), and receive information associated with the plurality of computing devices from the M2M system (e.g., referred to as a second set of device information) (215). Depending on implementation, the compliance system 130 can receive the first set and the second set of device information concurrently, one after the other, and/or periodically from the MDM system and the M2M system, respectively. The compliance system 130 can also periodically receive, from individual computing devices of the plurality of computing devices, device information from a service application running on that computing device. The received information can be stored in a data store of the compliance system 130.

The compliance system 130 can access a set of policies and use the received information to determine whether a policy(ies) needs to be enforced for one or more of the computing devices. In some examples, the compliance system 130 can perform this check periodically (e.g., every five seconds, every ten seconds, every hour, etc.) and/or when new device information is received and/or when a policy is created, edited, or deleted by a user. The compliance system 130 can identify a policy, from the set of policies, to be enforced based on the first set of device information, the second set of device information, and/or device information received from service applications running on the plurality of computing devices (220). The compliance system 130 can also identify a particular computing device(s) that the policy is to be enforced for. In some examples, although the compliance system 130 can identify multiple policies for one or more devices or one policy for multiple devices, for simplicity in describing the exemplary method of FIG. 2, only a single policy for a single computing device is described.

Each policy can specify an action that is to be performed (e.g., by the compliance system 130, the MDM system, and/or the M2M system, etc.) with respect to one or more of the computing devices. By identifying the policy based on received device information, the compliance system 130 can determine an action that is to be performed on the identified computing device (230). The compliance system 130 can then transmit a request to the MDM system, the M2M system, and/or the service application running on the identified computing device based on the determined action in order to enforce the policy (240). In this manner, in some examples, the compliance system 130 can cause the MDM system to perform an action based on device information received from the M2M system, or vice versa.

### Use Case Examples

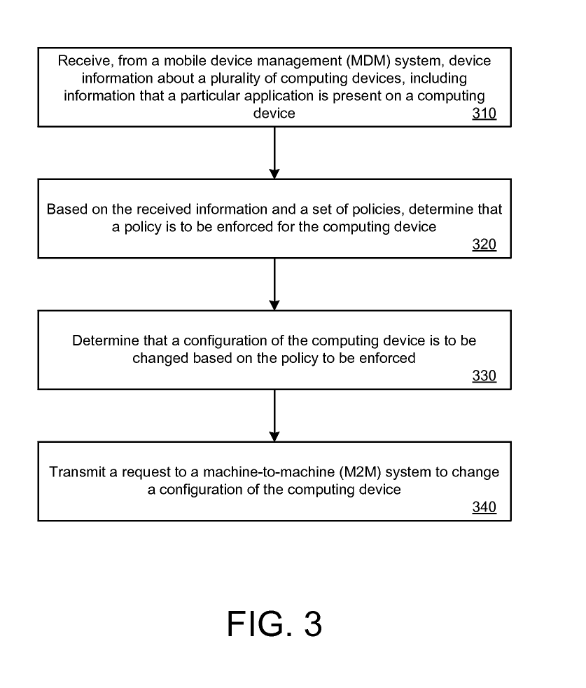

Some examples of use cases and policies are described herein for illustrative purposes. FIG. 3 illustrates an example method performed by a compliance system, such as the compliance system 130 of FIG. 1, for performing policy enforcement. The compliance system 130 can be in communication with an MDM system, such as the MDM system 110, to receive device information about a plurality of computing devices (310). The device information can include information about which applications that are present or installed on individual computing devices (e.g., stored in a memory resource of individual computing devices). In the example of FIG. 3, the MDM system 110 can determine that a computing device, Device A, has a particular application, App X, that is stored on Device A. The MDM system 110 can provide the device information about a plurality of computing devices (Devices A, B, C, D, and E) to the compliance system 130, including information that Device A has App X stored in its memory resource (but not Devices B, C, D, or E).

Based on the received information and the set of policies, the compliance system 130 can determine that a policy is to be enforced for one or more computing devices (320). In one example, a policy of the set of policies can specify that when the compliance system 130 detects that a device stores a particular application (or a specific type of application, e.g., game application, financial application, media application, etc.), an action is to be performed with respect to that device. The compliance system 130 can determine that a configuration of the identified one or more computing devices is to be changed based on the policy to be enforced (330). In this example, the action can correspond to (i) preventing a service provider of Device A from launching App X, (ii) remotely deleting App X from Device A, (iii) locking Device A to prevent the service provider from substantially operating Device A in its entirety, (iv) changing the state of the subscriber identity module (SIM) of Device A, and/or (v) performing other actions with respect to Device A (generally referred to as changing the configuration of a device).

The compliance system 130 can transmit a request to the M2M system to change the configuration of the computing device (340). For example, the specified action from the policy may be to change the state of the SIM of Device A from an “active” or “activated” state to another state, such as “deactivated” or “activation ready” state (referred to herein for simplicity as “deactivated” state). The latter state can be a state that prevents Device A from having network (e.g., cellular) connectivity via the network provider's wireless network, as compared to the former state in which Device A can use the network to exchange data. As such, when the M2M system receives the request and changes the state as directed, Device A can be barred from exchanging data over a data channel via the wireless network, thereby preventing the service provider from using the service arrangement entity's system to receive invitations for transport. The reasoning behind such a policy may be to prevent a service provider from improperly operating a device (e.g., use the device for personal use as opposed to for furthering the business partnership between the service provider and the service arrangement entity).

In one example, a user of the compliance system 130 can create a policy that identifies a plurality of applications or application types that are not to be installed or downloaded on a computing device. In another example, the user can create multiple policies, with each policy specifying a particular application or application type that is not to be installed or downloaded on a computing device. In this manner, by using the information about applications on computing devices received from the MDM system, the compliance system 130 can control actions to be performed by the M2M system.

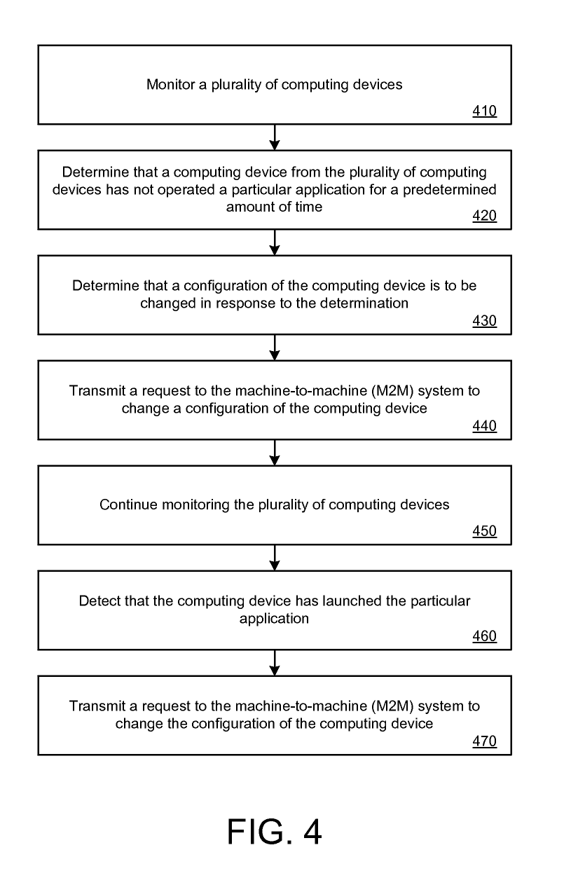

FIG. 4 illustrates another example method performed by a compliance system for performing policy enforcement. In this example, a policy can specify that if a service provider of a computing device has not used the service application (or has not launched the service application) for a period of time, the configuration of the computing device should be changed (e.g., change the SIM status of that computing device from “activated” to “deactivated”). Referring to FIG. 4, the compliance system 130 can monitor a plurality of computing devices (410). The compliance system 130 can monitor the computing devices based on device information received from the MDM system, the M2M system, and/or the service applications on those devices.

By monitoring the plurality of computing devices (and also by using stored data of previously received device information and accessing the set of policies), the compliance system 130 can determine that a computing device from the plurality of computing devices has not operated a particular application (e.g., the service application) for a predetermined period of time (e.g., five days, ten days, twenty eight days, etc.) (420). For example, whenever a service provider launches or opens the service application on his or her computing device, the service application can transmit data to the compliance system 130 (and/or via the service system). Depending on implementation, a timestamp can be included in the data indicating when the service application was launched or the compliance system 130 can record in a database, a time when the data was received from the service application. In other use case examples, rather than determining the duration of time that has elapsed since the last time the service application was launched, a policy can specify that a computing device should be deactivated when the service provider does not accept a transport invitation for a duration of time (despite the service application being open).

In response to this determination, the compliance system 130 can then determine, based on the policy, that a configuration of the computing device is to be changed (430). According to an example, the compliance system 130 can determine that the SIM status of the computing device is to be changed from an “activated” state to a “deactivated” state. The compliance system 130 can transmit a request to the M2M system to cause the M2M system to make the instructed change (440). In this manner, a computing device can be deactivated for financial savings purposes. The network provider may not charge the service arrangement entity a fee for providing network connectivity service to those computing devices having a SIM status of “deactivated” or any inactive/non-billable status (e.g., through agreements between the network provider and the service arrangement entity).

The compliance system 130 can continue to monitor the plurality of computing devices, including the computing device that had its SIM status changed to “deactivated” state in the previous step (450). In one example, when the compliance system 130 detects through information received from the service application (e.g., the computing device connects to another network, such as via Wi-Fi), that the service application has been launched (460), the compliance system 130 can transmit a request to the M2M system to change the configuration again of the computing device (470). The M2M can change the SIM status of the computing device from the “deactivated” state to the “activated” state.

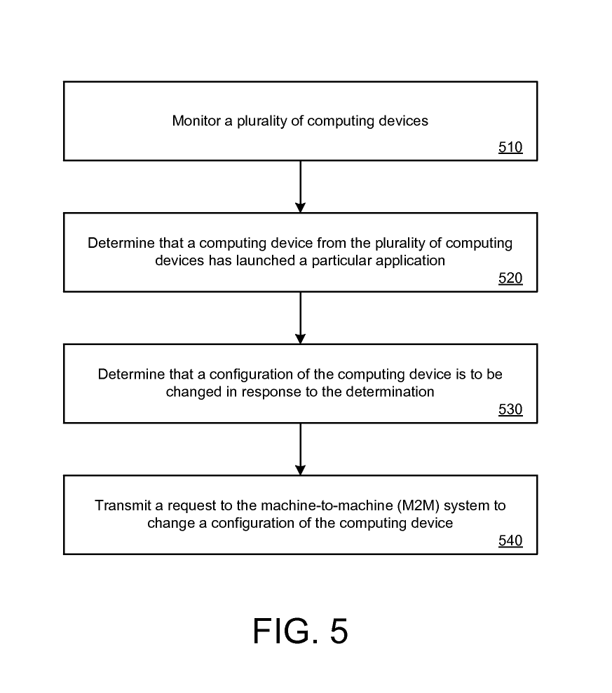

FIG. 5 illustrates another example method of performing policy enforcement. A policy described in FIG. 5 can be used to activate a computing device to enable the computing device to have cellular network service only when the service application is being operated on the computing device. If the service arrangement entity and the network provider has an agreement in which a fee is imposed only when the computing device has a SIM status of “activated” (as opposed to general month to month usage), the service arrangement entity can realize significant financial savings.

In the example of FIG. 5, the compliance system 130 can monitor a plurality of computing devices based on device information periodically received from the MDM system, the M2M system, and/or the service applications (510). When the compliance system 130 determines that a computing device has launched the service application by monitoring the devices (520), the compliance system 130 can determine that a configuration of the device is to be changed in response (530). For example, the compliance system 130 can enforce a policy that instructs the compliance system 130 to activate a device by changing the configuration of that device (e.g., change the SIM status from a default “deactivated” state to an “activated” state). Those computing devices that are not operating the service application can have their respective SIM statuses as being set to “deactivated.” The compliance system 130 can transmit a request to the M2M system to cause the M2M system to change the SIM status from the “deactivated” state to the “activated” state (540). In this manner, a computing device can have network connectivity via the network provider's network only when the service application is running on the computing device. Billing can then occur for the network service used by the computing device during this time.

In another use case and policy example, the compliance system 130 can receive, from the M2M system, information about the amount of data usage by individual computing devise. A policy can specify that if a device has exceeded 100 MBs of data usage in a month, a notification is to be sent to that device or a user operating that device (e.g., to a user's email address or via a text message). In addition, the compliance system 130 can transmit a request to the MDM system to lock the device and/or transmit a request to the M2M system to change a configuration of the device (e.g., from an “activated” state to a “deactivated” state). Such a notification can request that the user perform some action (e.g., call a representative of the service arrangement entity) before the device can be used. The notification can also be transmitted apart from the service application running on the device via the MDM system.

Still further, in another use case and policy example, the compliance system 130 can use information from the M2M system that a user operating a computing device has removed (e.g., taken out) the SIM card out of the computing device. A policy can instruct the compliance system 130 that when such an event occurs, the compliance system 130 is to transmit a request to the MDM system to lock the device from further use.

In another example, a policy can specify that the compliance system 130 can detect, via device information from the MDM system, when a computing device is connected to a network using Wi-Fi (as opposed to a cellular network). Content that require a large amount of network bandwidth, such as videos or audios, can be transmitted to computing devices for user consumption when the devices are using a Wi-Fi network connection. Other examples of policies include the compliance system 130 causing the MDM system to update one or more applications, including the service application, based on information determined from the M2M system or stored information.

According to variations, the compliance system 130 can perform the example methods and use cases described herein in conjunction with each other (e.g., concurrently). Multiple policies can be enforced on individual or multiple computing devices concurrently by directing one or more of the MDM system, the M2M system, or the service applications to perform specified actions.

### Hardware Diagrams

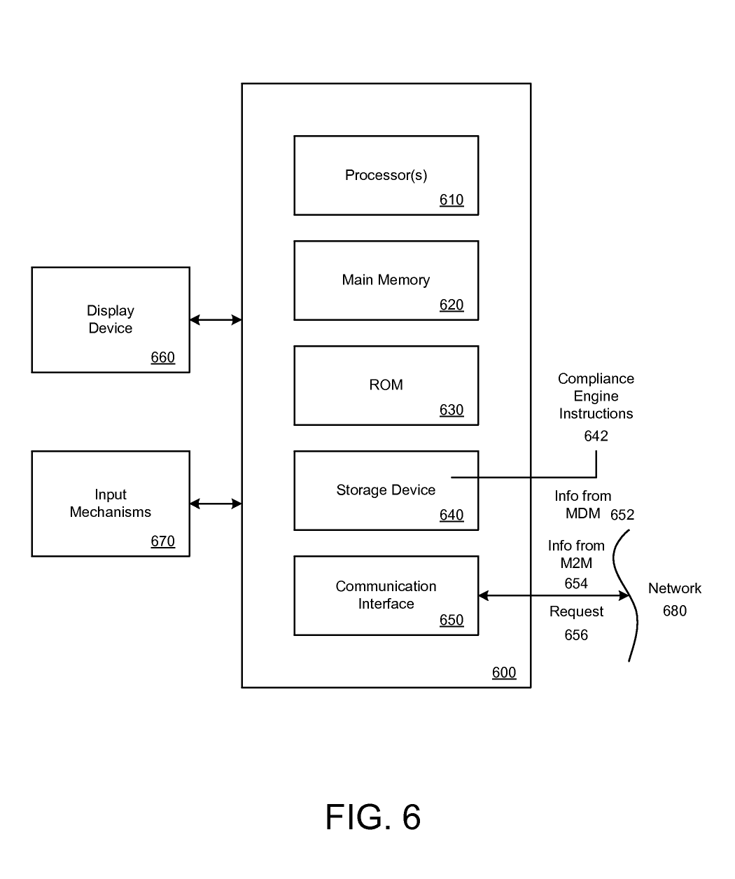

FIG. 6 is a block diagram that illustrates a computer system upon which embodiments described herein may be implemented. For example, in the context of FIG. 1, the compliance system 130 may be implemented using a computer system such as described by FIG. 6. The computer system 100 may also be implemented using a combination of multiple computer systems as described by FIG. 6.

In one implementation, the computer system 600 includes processing resources 610, a main memory 620, a read-only memory (ROM) 630, a storage device 640, and a communication interface 650. The computer system 600 includes at least one processor 610 for processing information, and the main memory 620, such as a random access memory (RAM) or other dynamic storage device, for storing information and instructions to be executed by the processor 610. The main memory 620 may also be used for storing temporary variables or other intermediate information during execution of instructions to be executed by the processor(s) 610. The computer system 600 may also include the ROM 630 or other static storage device for storing static information and instructions for processor 610. The storage device 640, such as a magnetic disk or optical disk, is provided for storing information and instructions, such as the compliance engine instructions 642 for implementing one or more components discussed with respect to the compliance system 130.

The communication interface 650 can enable the computer system 600 to communicate with one or more networks 680 (e.g., cellular network) through use of the network link (e.g., via wireless or wire). Using the network link, the computer system 600 can communicate with one or more computing devices and one or more servers, such as with a server(s) implementing the MDM system and a server(s) implementing the M2M system. Depending on examples, the computer system 600 can also be in communication with a service arrangement system or be a part of the service arrangement system. As discussed with respect to FIGS. 1 through 5, the computer system 600 can communicate, via the network link, with the MDM system and the M2M system to receive device information from the MDM system 652 and device information from the M2M system 654, respectively. The computer system 600 can also communicate, via the network link, with a plurality of service applications that are operated on a plurality of computing devices. The storage device 640 can store the device information received from the MDM system 652 and the device information received from the M2M system 654. The storage device 640 can also store a set of policies that are created and/or edited by a user operating the computer system 600.

The computer system 600 can also include a display device 660, such as a cathode ray tube (CRT), an LCD monitor, or a television set, for example, for displaying graphics and information to a user. An input mechanism 670, such as a keyboard that includes alphanumeric keys and other keys, can be coupled to the computer system 600 for communicating information and command selections to the processor 610. Other non-limiting, illustrative examples of input mechanisms 670 include a mouse, a trackball, touch-sensitive screen, or cursor direction keys for communicating direction information and command selections to the processor 610 and for controlling cursor movement on the display 660.

Examples described herein are related to the use of the computer system 600 for implementing the techniques described herein. According to one embodiment, those techniques are performed by the computer system 600 in response to the processor 610 executing one or more sequences of one or more instructions contained in the main memory 620. Such instructions may be read into the main memory 620 from another machine-readable medium, such as the storage device 640. Execution of the sequences of instructions contained in the main memory 620 (e.g., the compliance engine instructions 642) causes the processor 610 to perform the process steps described herein. In alternative implementations, hard-wired circuitry may be used in place of or in combination with software instructions to implement examples described herein. Thus, the examples described are not limited to any specific combination of hardware circuitry and software.

In some examples, the processor 610 can execute the compliance engine instructions 642 to implement the data collect 140 and the compliance engine 160. The processor 610 can receive and process device information received from the MDM system 652, device information received from the M2M system 654, and/or device information received from the service applications in order to identify one or more policies that are to be enforced for one or more of the plurality of computing devices. If a policy is to be enforced on one or more computing devices, the processor 610 can generate a request 656 to be transmitted to the MDM system, the M2M system, and/or the service application to cause an action that is specified by the policy to be performed with respect to the identified one or more computing devices.

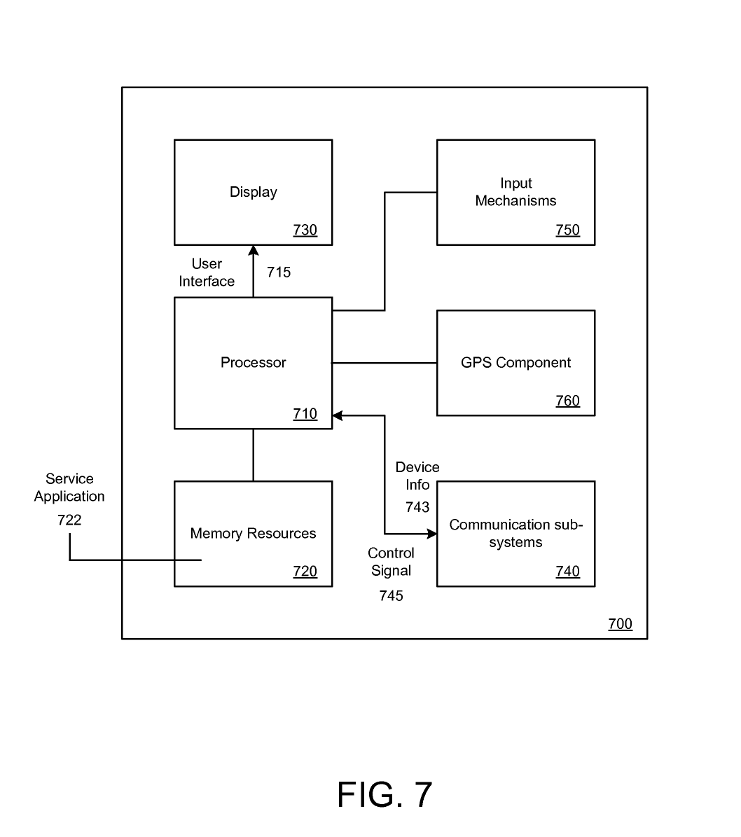

FIG. 7 is a block diagram that illustrates a mobile computing device upon which embodiments described herein may be implemented. In one embodiment, a computing device 700 may correspond to a mobile computing device, such as a cellular device that is capable of telephony, messaging, and data services. The computing device 700 can correspond to a client device or a driver device. Examples of such devices include smartphones, handsets or tablet devices to communicate with cellular carriers. The computing device 700 includes a processor 710, memory resources 720, a display device 730 (e.g., such as a touch-sensitive display device), one or more communication sub-systems 740 (including wireless communication sub-systems), input mechanisms 750 (e.g., an input mechanism can include or be part of the touch-sensitive display device), and one or more location detection mechanisms (e.g., GPS component) 760. In one example, at least one of the communication sub-systems 740 sends and receives cellular data over data channels and/or voice channels.

The processor 710 is configured with software and/or other logic to perform one or more processes, steps and other functions described with implementations, such as described by FIGS. 1 through 5, and elsewhere in the application. The processor 710 is configured, with instructions and data stored in the memory resources 720, to operate a service application as described in FIGS. 1 through 5. For example, instructions for operating the service application in order to display user interfaces 715 can be stored in the memory resources 720 of the computing device 700.

A service provider can operate a service provider device (such as the computing device 700) to operate a service application 722 to provide, to the compliance system and/or the service arrangement system, information about the service provider's status with regards to transport, to provide location information about the service provider device, and to accept or reject an invitation for a transport service if the invitation is provided to the service provider device from a service arrangement system.

The computing device 700 can provide a location data point, such as a location data point corresponding to the current location of the computing device 700, which can be determined from the GPS component 770. The location data point 765 can be transmitted wirelessly (and periodically) to the transport service system via the communication sub-systems 740 when the service application 722 is operated or running on the computing device 700.

According to some examples, the computing device 700 can also provide device information 743 to the MDM system and/or the M2M system (e.g., outside of the operation of the service application 722). For example, an MDM client service or program operating on the computing device 700 (e.g., stored in the memory resources 720) can cause a first set of device information 743 to be provided to the MDM system, while an M2M client service or program operating on the computing device 700 can cause a second set of device information 743 to be provided to the M2M system via the communications sub-systems 740. Although not illustrated in FIG. 7, the computing device 700 can include a SIM card that is specific to that computing device 700, which can be controlled by the M2M system, for example, through use of control signals 745. When policies are to be enforced with respect to the computing device 700, the computing device 700 can receive a control signal 745 from one or more of the MDM system, the M2M system, and/or the compliance system (or the service arrangement system) that causes the processor 710 to perform a respective action, such as to change a configuration of the computing device 700, as described in FIGS. 1 through 5.

The processor 710 can also provide a variety of content to the display 730 by executing instructions and/or applications that are stored in the memory resources 720, such as instructions corresponding to the service application 722. One or more user interfaces 715 can be provided by the processor 710, such as a user interface for the service application 722. In some examples, when the processor 710 performs a programmatic action as a result of receiving a control signal 745, the processor 710 can also cause a user interface feature 715 (e.g., a message or a notification) to be displayed on the display 730. While FIG. 7 is illustrated for a mobile computing device, one or more embodiments may be implemented on other types of devices, including full-functional computers, such as laptops and desktops (e.g., PC).

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other example, even if the other features and examples make no mentioned of the particular feature. Thus, the absence of describing combinations should not preclude from claiming rights to such combinations.

What is being claimed is:

1. A method for performing policy enforcement, the method being performed by one or more processors of a first system and comprising:
receiving, at the first system from a mobile device management (MDM) system over one or more networks, a set of information associated with a plurality of computing devices, the MDM system being in communication with the plurality of computing devices;
determining, from the set of information, data indicating that a particular application is stored on a computing device of the plurality of computing devices;
identifying, at the first system, an action that is to be performed in association with the computing device, wherein identifying the action includes identifying a policy from a set of policies based on the data, each of the set of policies specifying a corresponding action to be performed and being stored in a memory resource accessible by the first system; and
transmitting, from the first system to a machine-to-machine (M2M) system over the one or more networks, a request to change a configuration of the computing device based on the identified action.

2. The method of claim 1, wherein the MDM system determines that the particular application is present on the computing device in response to detecting that the particular application is installed in a memory resource of the computing device.

3. The method of claim 1, wherein the MDM system and the M2M system are operated by different entities, and wherein the MDM system and the M2M system are implemented on individual computing systems.

4. The method of claim 1, wherein receiving the set of information from the MDM system is performed periodically.

5. The method of claim 1, wherein for each computing device of the plurality of computing device, the set of information includes at least one or more of: (i) information about a device type of that computing device, (ii) an identifier of that computing device, (iii) an internet protocol (IP) address of that computing device, (iv) a media access control (MAC) address of that computing device, (v) an identifier corresponding to a carrier, (vi) a profile associated with that computing device, (vii) information about one or more applications stored on that computing device, (viii) compliance status of that computing device, or (ix) location information of that computing device.

6. The method of claim 1, wherein the request to change the configuration of the computing device causes the M2M system to change a state of a subscriber identity module (SIM) of the computing device from a first state to a second state.

7. The method of claim 6, wherein changing the state of the SIM of the computing device from the first state to the second state prevents the computing device from exchanging data using a cellular network provided by a telecommunication network provider.

8. A system comprising:
one or more communication interfaces;
one or more processors coupled to the one or more communication interfaces; and
a memory resource storing instructions that, when executed by the one or more processors, causes the one or more processors to:
receive, at the system from a mobile device management (MDM) system over one or more networks via the one or more communication interfaces, a set of information associated with a plurality of computing devices, the MDM system being in communication with the plurality of computing devices;
determine that a policy is to be enforced for a computing device of the plurality of computing devices based on the received set of information associated with the plurality of computing devices, the set of information including data indicating that a particular application is stored on the computing device;
identify, from the policy, an action that is to be performed in association with the computing device; and
transmit, from the first system to a machine-to-machine (M2M) system over the one or more networks via the one or more communication interfaces, a request to change a configuration of the computing device based on the identified action.

9. The system of claim 8, wherein the MDM system determines that the particular application is present on the computing device in response to detecting that the particular application is installed in a memory resource of the computing device.

10. The system of claim 8, wherein the MDM system and the M2M system are operated by different entities, and wherein the MDM system and the M2M system are implemented on individual computing systems.

11. The system of claim 10, wherein the M2M system is operated by a telecommunications network provider, and wherein the system is operated by an entity that provides a service arrangement system.

12. The system of claim 11, wherein the request includes an identifier of the computing device and instructions corresponding to the change to the configuration that is to be made.

13. The system of claim 12, wherein the change to the configuration corresponds to a change of a state of a subscriber identity module (SIM) of the computing device from a first state to a second state.

14. The system of claim 13, wherein when the SIM is in the second state, the computing device is prevented from exchanging data using a cellular network provided by the telecommunication network provider.

15. A method for performing policy enforcement, the method being performed by one or more processors of a first system and comprising:
monitoring, at the first system, a plurality of computing devices;
determining that a computing device of the plurality of computing devices has not operated a particular application for a predetermined amount of time; and
in response to determining that the computing device has not operated the particular application for the predetermined amount of time, transmitting, to a machine-to-machine (M2M) system over one or more networks, a request to change a configuration of the computing device from an activated state to a deactivated state.

16. The method of claim 15, wherein monitoring the plurality of computing devices includes, for each of the plurality of computing devices, (i) detecting when that computing device launches the particular application, and (ii) storing a record indicating a time when that computing device launched the particular application.

17. The method of claim 15, wherein transmitting the request includes transmitting the request to the M2M system to change a subscriber identity module (SIM) card of the computing device.

18. The method of claim 15, wherein the predetermined amount of time is specified by a policy from a set of policies that is accessed by the first system.

19. The method of claim 15, wherein monitoring the plurality of computing devices includes periodically receiving, over the one or more networks, information from a respective particular application operating on each of the plurality of computing devices.

20. The method of claim 15, wherein monitoring the plurality of computing devices includes periodically receiving, over the one or more networks, a set of information associated with the plurality of computing devices from a mobile device management (MDM) system.
